(19) United States
(12) Patent Application Publication
(10) Pub. No.: US 2016/0086704 A1
(43) Pub. Date: Mar. 24, 2016

(54) METHOD OF MANUFACTURING ANISOTROPIC HOT-DEFORMED MAGNET USING HOT-DEFORMATION PROCESS AND HOT-DEFORMED MAGNET MANUFACTURED THEREBY

(71) Applicant: LG ELECTRONICS INC., Seoul (KR)

(72) Inventors: Seok NAMKUNG, Seoul (KR); Nameseok KANG, Seoul (KR); Deokhai PARK, Seoul (KR)

(21) Appl. No.: 14/889,589

(22) PCT Filed: Jul. 24, 2014
(86) PCT No.: PCT/KR2014/006765

§ 371 Date: Nov. 6, 2015

(30) Foreign Application Priority Data
Sep. 24, 2013 (KR) 10-2013-0113428

(51) Int. Cl. H01F 1/057; B22F 3/24; B22F 9/30; B22F 3/16; H01F 41/02; B22F 9/04

(52) U.S. Cl. CPC H01F 1/0577; H01F 41/0266; H01F 41/0293; B22F 9/04; B22F 9/30; B22F 3/16; B22F 3/24; B22F 2301/35; B22F 2301/45; B22F 2301/205; B22F 2301/20; B22F 2302/45; B22F 2003/248

(57) ABSTRACT

The method for fabricating an R—Fe—B hot-deformed magnet according to the present invention includes: preparing an R—Fe—B magnetic powder; mixing the magnetic powder with a high-melting point metal or a metal compound including the high-melting point metal; press sintering the mixture; and hot-deforming the sintered body by applying heat and pressure, and thus may suppress the growth of crystal grains, and does not need a sintering process of 1,000° C. or more, and the magnetization direction of crystal grains is arranged in one direction even without applying the magnetic field by the hot deformation, and thus, a hot-deformed magnet may be more economically produced. Further, the R—Fe—B hot deformed magnet of the present invention includes a structure in which anisotropic plate-shaped crystal grains of uniform size having an average diameter of 400 to 900 nm are evenly distributed throughout the magnet, and has a uniform and minute size of crystal grains in the magnet, and thus, may secure excellent coercive force, and plate-shaped crystal grains formed by the hot deformation may have excellent residual magnetic flux density because the magnetization direction is arranged in one direction.

### TECHNICAL FIELD

The present invention relates to an anisotropic hot-deformed magnet, and more particularly, to a method for fabricating an anisotropic hot-deformed magnet having excellent coercive force and residual magnetic flux density without imparting an external magnetic field during a heat treatment and a process at high temperature (1,000° C.) through a hot deformation process, and a hot-deformed magnet fabricated by the same method.

### BACKGROUND ART

The environmentally friendly energy industry such as the new renewable energy has recently drawn great attention, but it may also be important to improve the efficiency of a device which consumes energy in terms of conversion of the energy production system and energy consumption. The most important device, which is associated with the energy consumption, is a motor, and the essential material for the motor is a rare earth permanent magnet. In order for the rare earth permanent magnet to be used as an excellent material in various application fields, both high residual magnetic flux density (Br) and stable coercive force (iHc) are required.

One of the methods for securing high coercive force of a magnetic powder is a method for using the magnetic powder by adding a heavy rare earth such as Dy to increase coercive force at room temperature. However, it seems that there is a limitation in recently using a heavy rare earth metal such as Dy as a material in the future due to the scarcity of the heavy rare earth metal and a soaring increase in prices resulting therefrom. Further, the addition of Dy improves coercive force, but has a disadvantage in that the remnance is reduced, and as a result, the intensity of the magnet becomes weak.

Meanwhile, in the method for fabricating an anisotropic neodymium-based permanent magnet, the magnet is usually fabricated by preparing a magnetic powder through metal melting, rapid cooling, and milling, forming the magnetic powder while applying a magnetic field, and then sintering the magnetic powder at high temperature (1,000° C. or more), and subjecting the magnetic powder to post-heat treatment. During the process, another method of the methods for securing high coercive force of a magnetic powder is the micronization of the size of crystal grains to the magnetic domain size.

That is, the method is to micronize crystal grains of the magnetic powder by minutely pulverizing the grains using a physical method, and in this case, it also is necessary to micronize the particle diameter of the magnetic powder itself prior to the sintering in the steps of the fabrication method in order to micronize the crystal grains of the magnetic powder, but there is also a need for maintaining the magnetic powder of the micro crystal grains until a final product is produced.

However, in the process of fabricating a minutely pulverized magnetic powder having a micro-size particle diameter into a magnet, the coercive force is significantly reduced, the size of particles is non-uniform, and thus, it is difficult to obtain crystal grains arranged in one direction because the growth of micro-size crystal grains occurs on the surface portions which have high energy and many defects due to the high temperature heat treatment exceeding 1,000° C., and the nucleation of the reverse domain in the particle may not be suppressed due to the coarsening of crystal grains on the surface sites, and accordingly, there is a disadvantage in that the residual magnetic flux density is also measured at significantly low values.

### DISCLOSURE OF THE INVENTION

Therefore, an object of the present invention is to provide provide a method for fabricating an anisotropic hot-deformed magnet which is excellent in coercive force by adding a high-melting point metal to suppress coarsening of crystal grains on the surface site of a powder without a high temperature sintering process at 1,000° C. or more, and is excellent in residual magnetic flux density by applying a hot deformation process even without applying an external magnetic field to arrange the magnetization direction, and a hot-deformed magnet fabricated by the method.

To achieve these and other advantages and in accordance with the purpose of the present invention, as embodied and broadly described herein, there is provided a method for fabricating a hot-deformed magnet according to the present invention including: preparing an R—Fe—B magnetic powder (R is a rare earth metal selected from Nd, Pr, Tb, Ho, Sm, Sc, Y, La, Ce, Pm, Eu, Gd, Er, Tm, Yb, and Lu, or a combination thereof); forming a mixture by mixing the magnetic powder with a high-melting point metal (one or more metals selected from Nb, V, Ti, Cr, Mo, Ta, W, Zr, and Hf) or a metal compound including the high-melting point metal; press sintering the mixture; and hot-deforming the sintered body by applying heat and pressure.

The magnetic powder may be prepared by pulverizing an R—Fe—B alloy, or prepared by the hydrogenation decomposition desorption recombination (HDDR) method.

The magnetic powder may be a multi-crystal particle, and the magnetic powder may have an average particle diameter of 100 to 500 μm.

The press sintering may be performed by any one method selected from the group consisting of a hot press sintering, a hot isotactic pressing, a spark plasma sintering, a furnace sintering, and a microwave sintering.

The press sintering may be performed under the conditions of a temperature of 500 to 800° C. and a pressure of 30 to 500 MPa, and the hot-deforming may be performed under the conditions of a temperature of 600 to 1,000° C. and a pressure of 50 to 500 MPa.

The fabrication method may not include magnetic field forming, which applies an external magnetic field.

The magnet according to the present invention is an R—Fe—B hot-deformed magnet and includes a structure in which anisotropic plate-shaped crystal grains of uniform size having a diameter of 100 to 1,000 nm are evenly distributed throughout the magnet, and R may be a rare earth metal selected from Nd, Pr, Tb, Ho, Sm, Sc, Y, La, Ce, Pm, Eu, Gd, Er, Tm, Yb, and Lu, or a combination thereof.

The crystal grains may have an average diameter of 400 to 900 nm, the magnet may include a high-melting point metal component, and the high-melting point metal may be one or more metals selected from Nb, V, Ti, Cr, Mo, Ta, W, Zr, and Hf.

The R—Fe—B hot-deformed magnet may be a neodymium-based magnet or a non-neodymium-based magnet.

Hereinafter, the present invention will be described in more detail.

The method for fabricating a hot-deformed magnet according to the present invention includes: preparing an R—Fe—B magnetic powder (R is a rare earth metal selected from Nd, Pr, Tb, Ho, Sm, Sc, Y, La, Ce, Pm, Eu, Gd, Er, Tm, Yb, and Lu, or a combination thereof); mixing the magnetic powder with a high-melting point metal (one or more metals selected from Nb, V, Ti, Cr, Mo, Ta, W, Zr, and Hf) or a metal compound including the high-melting point metal; press sintering the mixture; and hot-deforming the sintered body by applying heat and pressure.

First, a step of preparing of the magnetic powder will be described.

The magnetic powder may be prepared by pulverizing an R—Fe—B alloy ingot, or may be prepared by the HDDR method. Specifically, the alloy ingot is molten by the fabrication method by pulverizing the alloy ingot, the melt alloy is prepared into a ribbon shape through a high-speed rolling, and then a magnetic powder may be prepared by a method for pulverizing the ribbon-shaped alloy through a milling apparatus. Alternatively, a magnetic powder may be prepared by subjecting the alloy ingot to hydrogenation, disproportionation, dehydrogenation, and recombination by the HDDR process as a method well known in the technical field.

The magnetic powder may be a polycrystalline particle, and may have an average particle diameter of 100 to 500 μm. In the existing method for fabricating a permanent sintered magnet, the magnetic powder should be pulverized to about 3 μm, which is a single crystal particle diameter before reaching the sintering process. Accordingly, when the magnetic powder is prepared, rolling should be performed at low speed, and milling is also subjected to crude pulverization and minute pulverization processes. In contrast, the magnetic powder of the present invention has an advantage in that it is possible to bring about an effect of reducing the process costs because the magnetic powder is suitable as long as the magnetic powder is a polycrystalline particle in which a plurality of crystal grains is present therein, and has an average particle diameter of 100 to 500 μm.

Secondly, a step of performing the mixing will be described.

The mixing may be mixing the above-prepared magnetic powder with a high-melting point metal or the magnetic powder with a metal compound including the high-melting point metal. That is, what is mixed with the magnetic powder may be not only a high-melting point metal, but also a metal compound including the high-melting point metal. The high-melting point metal is mainly composed of a refractory metal, may be, for example, Nb, V, Ti, Cr, Mo, Ta, W, Zr or Hf, and the like, and the metal compound including the high-melting point metal may be, for example, an alloy such as FeNb and Nb3Ga, an oxide such as Nb2O5, a chloride such as NbC15, or a fluoride such as NbF5, and the like.

In the case of the metal compound including the high-melting point metal, a solvent capable of easily dissolving a high-melting point metal may be used, it is preferred to use a solvent in which only the high-melting point metal is left, and thus, the high-melting point metal may be evenly applied on the surface of the powder after the solvent is dried, and the solvent does not include moisture or carbon and it is preferred to minimize oxidation of the magnetic powder and deterioration in magnetic characteristics.

The high-melting point metal or the metal compound including the high-melting point metal is mixed with the magnetic powder in a dry or wet manner, and in the case of the wet mixing, the solvent is completely dried after the mixing, and then the next process may be performed. By the mixing, the high-melting point metal is uniformly coated on the surface of the magnetic powder, and then it is possible to suppress production of large particles, that is, coarsening of crystal grains during the press sintering or hot deformation subsequently performed.

When the coercive force mechanism is examined in connection with mixing with the high-melting point metal or the metal compound including the high-melting point, the coercive force refers to intensity of a magnetic field which makes the degree of magnetization become 0 by applying a reverse magnetic field to a magnetized magnetic body, and may be increased as production of the reverse domain may be reduced under the reverse magnetic field. If there are a lot of surface defects, the reverse domain is easily produced even when the reverse magnetic field is low, and once the reverse domain is produced, the magnetic domain wall moves, and accordingly, the coercive force, which is a force for maintaining the magnetization, is decreased.

Specifically, the polycrystalline particles, which are a magnetic powder, are apt to coarsening of crystal grains as the particles are placed in a high-temperature environment while the boundary between crystal grains disappears as the intrinsic characteristics of crystal grains. For the coarsening, coarsening in the crystal grains exposed to the surface of the magnetic powder among the crystal grains included in the magnetic powder occurs first of all, because the surface is in high energy state, and thus, is unstable and has many defects.

However, when the high-melting point metal or the metal compound including the high-melting point metal is coated on the surface of the magnetic powder as in the present invention, the high-melting point metal serves to suppress the growth of crystal grains at high temperature while being present on the surface of the powder even after the press sintering or hot deformation, and as a result, there are so many surface defects that the coercive force may be increased because the coarsening may be suppressed even in the crystal grains disposed on the surface of the magnetic powder which is apt to coarsening of crystal grains, and furthermore, it is also possible to improve uniformity of the arrangement direction of crystal grains, which may be distorted by coarse crystal grains.

Thirdly, a step of performing the press sintering will be described.

The press sintering is not particularly limited in terms of method, as long as the sintering may be achieved, but the press sintering may be performed by any one method selected from the group consisting of a hot press sintering, a hot isotactic pressing(a hot isotactic press sintering), a spark plasma sintering, a furnace sintering, and a microwave sintering. The press sintering process is a step of densely binding the magnetic powder and may be a step of densifying the magnet into a predetermined shape without modification of crystal grains, and at this time, the crystal grains in the magnetic powder particle have a size of approximately 30 to 100 nm.

The press sintering may be performed under the conditions of a temperature of 500 to 800° C. and a pressure of 30 to 500 MPa. The press sintering temperature is about 200 to 500° C. lower than the temperature at which the existing permanent sintered magnet is fabricated, and process costs or apparatus costs may be reduced by relaxing the temperature conditions. When the press sintering process is performed in the ranges of the temperature and the pressure, the magnetic powder is densely sintered, and growth does not occur in the crystal grains on the surface of the magnetic powder, and thus, it is possible to expect that the coercive force is improved.

Fourthly, a step of performing the hot deformation will be described.

The step is performed at higher temperature and pressure than in the press sintering and is a step of compressing the closely formed magnet, and thus, it is preferred that the step is performed in a device having an open side site, which is vertical to a direction of applying pressure, such that the thickness may be decreased and the area may be widened.

Specifically, crystal grains, from which the magnetic powder is densified in the press sintering process, and having a size of approximately 30 to 100 nm present in the magnetic powder particles by strong compression due to high pressure in the hot deformation process, are modified in a plate-shape while diffusing and growing at a predetermined size, and the crystal grains having this shape have anisotropy because the magnetization direction is arranged in one direction as crystallographic characteristics. That is, the performing of the hot deformation is a step which affects the residual magnetic flux density which is a measure of evaluating the performance of a magnet along with the coercive force, and excellent residual flux density may be obtained by the hot deformation as described above.

The hot deformation step may be performed under the conditions of a temperature of 600 to 1,000° C. and a pressure of 50 to 500 MPa. If the temperature is lowered below 600° C., crystal grains of the sintered magnet are not grown by diffusion, and thus are not formed as a plate shape, and when the temperature is raised above 1,100° C., coarsening of crystal grains rapidly occurs on the surface of the magnetic powder, and thus, the effects of the high-melting point metal disappear. Accordingly, 600 to 1,000° C. may be appropriate as the temperature of the hot deformation.

The method may not include magnetic field forming, which applies an external magnetic field. When crystal grains are modified into a plate shape through continuous compression by the hot deformation, the magnetization direction is arranged in one direction in crystallographically plate-shaped crystal grains even though a magnetic field is not imparted to a magnet by applying an external magnetic field, thereby obtaining excellent residual magnetic flux density. Accordingly, an effect which may reduce process costs and apparatus costs is brought about because a device of imparting a magnetic field or a step of magnetic field forming is not needed.

The magnet according to the present invention is an R—Fe—B hot-deformed magnet and includes anisotropic plate-shaped crystal grains having a uniform size of 100 to 1,000 nm in diameter, and the R—Fe—B hot-deformed magnet may be a neodymium-based magnet or a non-neodymium-based magnet. Here, R may be a rare earth metal selected from Nd, Pr, Tb, Ho, Sm, Sc, Y, La, Ce, Pm, Eu, Gd, Er, Tm, Yb, and Lu, or a combination thereof.

The magnet according to the present invention is characterized in that all the crystal grains have a plate-shape (pan-cake shape), and crystal grains are formed in a uniform size throughout the magnet, and this characteristic is a result obtained by effectively suppressing crystal grains from growing on the surface site of the powder.

The crystal grains may have an average diameter of 400 to 900 nm, a thickness of about 50 to 200 nm, and a width of about 100 to 1,000 nm.

Since the size of crystal grains is in minute and crystal grains having a plate shape are formed in a uniform size throughout the magnet, excellent coercive force and residual magnetic flux density may be obtained.

The magnet may include a high-melting point metal, for example, one or more metal components selected from Nb, V, Ti, Cr, Mo, Ta, W, Zr, and Hf at the crystal grain boundary.

Since the description of the high-melting point metal and the anisotropic plate-shaped crystal grains is overlapping with the aforementioned description of the method for fabricating a hot-deformed magnet, the description thereof will be omitted.

The method for fabricating an anisotropic hot-deformed magnet according to the present invention may suppress the growth of crystal grains occurring on the surface site of a powder even in the sintering process at high temperature by adding a high-melting point metal and introducing the hot deforming, and does not need a sintering process of 1,000° C. or more, and the magnetization direction of crystal grains is arranged in one direction even without applying the magnetic field by the hot deformation, and thus, a hot-deformed magnet may be fabricated by a more economic process.

Further, the hot-deformed magnet of the present invention has a uniform and minute size of crystal grains in the magnet, and thus, may secure excellent coercive force, and plate-shaped crystal grains formed by the hot deformation may have excellent residual magnetic flux density because the magnetization direction is arranged in one direction.

### BRIEF DESCRIPTION OF THE DRAWINGS

FIG. 1 is a photograph of the inner structure of the hot-deformed magnet fabricated in Example 2, which is observed by a scanning electron microscope (SEM). It can be confirmed that the growth of particles is suppressed on the surface site (arrow mark) of the powder; and

FIG. 2 is a photograph of the inner structure of the hot-deformed magnet fabricated in Comparative Example 1, which is observed by a scanning electron microscope (SEM). Coarse crystal grains may be observed on the surface site (arrow mark) of the powder.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

Hereinafter, exemplary embodiments of the present invention will be described in detail with reference to accompanying drawings, such that those skilled in the art to which the present invention pertains can easily carry out the present invention. However, the present invention can be implemented in various different forms, and is not limited to the exemplary embodiments described herein.

### EXAMPLES

### Example 1

### Preparation of Neodymium-Based Magnetic Powder

An alloy in the form of a ribbon was prepared by melting an NdFeB-based powder (Nd30Co5.0Ga0.5B0.9FeBaI.) as a raw material, and introducing the melt into a cooling roll which was rotated at high speed. A neodymium-based magnetic powder was prepared by milling the ingot in the form of a ribbon produced by the rolling process to pulverize the ingot into a size of about 200 μm [a step of preparing a magnetic powder].

### Example 2

### Preparation of Neodymium-Based Magnetic Powder to which High-Melting Point Metal is Added

In order to coat the neodymium-based magnetic powder prepared in Example 1 with a high-melting point metal, a fluoride NbF5 solution including niobium (Nb) as the high-melting point metal was mixed with the magnetic powder under the atmosphere of argon which is an inert gas, and the magnetic powder in the form of slurry by the mixing was dried [coating step]. The magnetic powder was injected into an extrusion mold for forming, and press sintering was performed such that the mold could be pressurized at a pressure of 90 MPa and a temperature of approximately 700° C. to maintain the shape while the powder was not decomposed [press sintering step]. Next, the press sintered magnet was removed from the mold, and all the crystal grains in the powder coated with the high-melting point metal were allowed to be in the form of a plate by using a press apparatus with all directions open to pressurize the magnet only in the upper and lower directions at a pressure of 100 MPa and a temperature of 800° C. [hot deforming step]. Due to the pressurization, the magnetization direction of each crystal grain was arranged in one direction even without applying a magnetic field, thereby fabricating an anisotropic hot-deformed magnet.

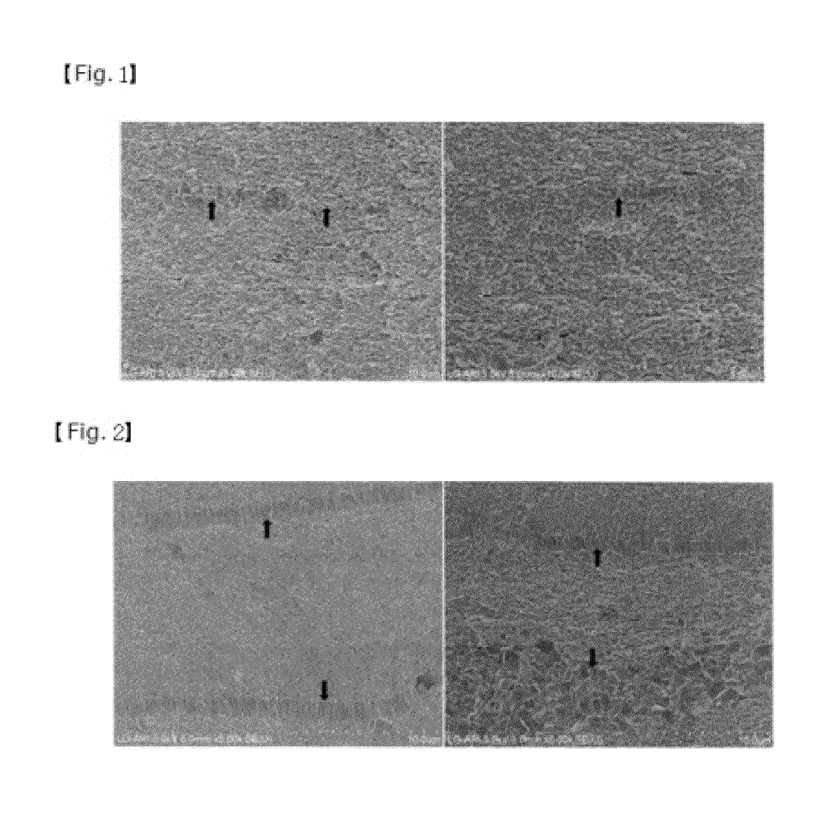

The inner structure of the fabricated magnet was observed by a scanning electron microscope (SEM), and was illustrated in FIG. 1. Referring to FIG. 1, it could be confirmed that crystal grains having a plate shape were formed in a uniform size throughout the magnet.

### Comparative Example 1

### Fabrication of Hot-Deformed Magnet to Which High-Melting Point Metal is Not Added

An anisotropic neodymium-based hot-deformed magnet was fabricated in the same manner as in Example 2, except that a step of coating the magnetic powder prepared in Example 1 with a high-melting point metal was excluded.

The inner structure of the fabricated magnet was observed by a scanning electron microscope, and was illustrated in FIG. 2. It could be confirmed that particles were grown in the perimeter of powder particles, and thus, coarse particles in the micrometer level were formed.

### Comparative Example 2

### Fabrication of Permanent Magnet by Existing Method for Manufacturing Sintered Magnet

The magnetic powder fabricated in Example 1 was pulverized by a jet mill to a particle diameter of about 3 μm. Thereafter, a solution including niobium (Nb) as a high-melting point metal was mixed with the magnetic powder under the atmosphere of argon which is an inert gas for the coating of the high-melting point metal, and the magnetic powder in the form of slurry by the mixing was dried. The magnetic powder was subjected to plasma heating at about 600° C. for plasticizing treatment, the plasticized body subjected to plasticizing treatment was injected into a forming mold, and then extruded into a predetermined shape while externally applying a magnetic field. Thereafter, the plasticized body was sintered at a pressure of 10-4 torr and a temperature of about 1,000° C. for 2 hours and cooled, and then was again subjected to heat treatment at a temperature of about 800° C. for 2 hours and at 500° C. for 2 hours, respectively, thereby fabricating a permanent sintered magnet.

As a result of observing the inner structure of the fabricated magnet by a scanning electron microscope, it can be confirmed that spherical crystal grains having a diameter of 0.8 to 1.2 μm were formed.

Although preferred examples of the present invention have been described in detail hereinabove, the right scope of the present invention is not limited thereto, and it should be clearly understood that many variations and modifications of those skilled in the art using the basic concept of the present invention, which is defined in the following claims, will also belong to the right scope of the present invention.

1. A method for fabricating an R—Fe—B hot-deformed magnet, the method comprising:
preparing an R—Fe—B (R is a rare earth metal selected from Nd, Pr, Tb, Ho, Sm, Sc, Y, La, Ce, Pm, Eu, Gd, Er, Tm, Yb, and Lu, or a combination thereof) magnetic powder;
forming a mixture by mixing the magnetic powder with a high-melting point metal (one or more metals selected from Nb, V, Ti, Cr, Mo, Ta, W, Zr, and Hf) or a metal compound comprising the high-melting point metal;
press sintering the mixture; and
hot-deforming the sintered body by applying heat and pressure.

2. The method of claim 1, wherein the magnetic powder is fabricated by pulverizing an R—Fe—B alloy, or fabricated by the hydrogenation decomposition desorption recombination (HDDR) method.

3. The method of claim 1, wherein the magnetic power is a multi-crystal particle.

4. The method of claim 1, wherein the magnetic powder has an average particle diameter of 100 to 500 μm.

5. The method of claim 1, wherein the press-sintering is performed by any one method selected from the group consisting of a hot press sintering, a hot isotactic pressing, a spark plasma sintering, a furnace sintering, and a microwave sintering.

6. The method of claim 1, wherein the press sintering is performed under the conditions of a temperature of 500 to 800° C. and a pressure of 30 to 500 MPa.

7. The method of claim 1, wherein the hot-deforming is performed under the conditions of a temperature of 600 to 1,000° C. and a pressure of 50 to 500 MPa.

8. The method of claim 1, wherein the method does not comprise magnetic field forming, which applies an external magnetic field.

9. A magnet which is an R—Fe—B (R is a rare earth metal selected from Nd, Pr, Tb, Ho, Sm, Sc, Y, La, Ce, Pm, Eu, Gd, Er, Tm, Yb, and Lu, or a combination thereof) hot-deformed magnet and comprises a structure in which anisotropic plate-shaped crystal grains of uniform size having a diameter of 100 to 1,000 nm are evenly distributed throughout the magnet.

10. The magnet of claim 9, wherein the crystal grains have an average diameter of 400 to 900 nm.

11. The magnet of claim 9, wherein the magnet comprises a high-melting point metal (one or more metal components selected from Nb, V, Ti, Cr, Mo, Ta, W, Zr, and Hf) component at the crystal grain boundary.

12. The magnet of claim 9, wherein the R—Fe—B hot-deformed magnet is a neodymium-based magnet or a non-neodymium-based magnet.
